(19) United States
(12) Patent Application Publication
(10) Pub. No.: US 2022/0411936 A1
(43) Pub. Date: Dec. 29, 2022

(54) BEARING COMPONENT

(71) Applicant: AKTIEBOLAGET SKF, GOTEBORG (SE)

(72) Inventors: Thilo von Schleinitz, Schweinfurt (DE); Christina Bruckhaus, Rednizhembach (DE)

(21) Appl. No.: 17/839,783

(22) Filed: Jun. 14, 2022

(30) Foreign Application Priority Data
Jun. 29, 2021 (DE) 102021206744.1

(51) Int. Cl. C23C 28/04; F16C 33/64; C23C 22/80; C23C 22/77; C23C 22/50; C23C 28/00

(52) U.S. Cl. CPC C23C 28/044; F16C 33/64; C23C 22/80; C23C 22/77; C23C 22/50; C23C 28/44

(57) ABSTRACT

A bearing component includes a black-oxide layer having metallic additional elements integrated in the structure of the black-oxide layer. Also a method of forming such a black-oxide layer that includes immersing the bearing component in a bath having the metallic additional element prior to immersing the bearing component in a black oxidation solution.

### CROSS-REFERENCE

This application claims priority to German patent application no. 10 2021 206744.1 filed on Jun. 29, 2022, the contents of which are fully incorporated herein by reference.

### TECHNOLOGICAL FIELD

The present disclosure is directed to a bearing component having a black oxide layer with metallic additional elements integrated therein.

### BACKGROUND

It is known to apply black oxides to bearing components, e.g., rolling-element bearing rings or rolling elements, in order to protect the bearing components against various damage typical for rolling-element bearings and occurring on the surface. Here the iron of the surface of the bearing component is immersed in one or more oxidizing baths. This produces a conversion layer fixedly connected to the base material that does not substantially influence the dimensions of the bearing component.

In very wear-intensive applications, the wear resistance of such a bearing black oxide is in part too low, with the result that the black oxide is already weakened or removed after a test run (after being “run in”) while it is resistant for years, however, in other more favorable applications. The observed removal of the layer is often related to components of a sliding motion of the component. While in pure rolling contact the layer is only smoothed but not removed, in sliding contact it can be removed after a short time since it has a lower hardness than the hardened bearing steel of the countersurface.

### SUMMARY

It is therefore an aspect of the present disclosure to provide a bearing component that has increased wear resistance.

In general, coatings can be favorably influenced by embedding additional materials therein. To date it has been known to produce a black-oxide layer on a bearing component and to subsequently apply a further layer that includes various additional elements, such as, for example, tungsten compounds, or also polymers, onto the black-oxide layer in order to reinforce it or to provide further properties for the layer. However, this has the disadvantage that the additional elements represent a separate layer that does not improve properties of the black-oxide layer itself, such as, for example, its wear resistance.

However, it has now been established by the inventor that it is possible to improve the properties of the black-oxide layer itself by carrying out a type of alloying of the black-oxide layer. The properties of the layer that arise during the black oxidation can be adapted, in particular improved, by such an alloying.

A bearing component is therefore disclosed that includes a black-oxide layer. The bearing component can in particular be a bearing component of a rolling-element bearing or plain bearing, such as, for example, a bearing ring or rolling element.

In order to provide a resistant black-oxide layer (e.g., wear resistant), metallic additional elements are integrated into the structure of the black-oxide layer. Here the metallic additional elements are not provided as a separate layer that provides its own properties, but rather they are embedded directly into the black-oxide layer, i.e., integrated in the structure of the black-oxide layer. In this way they change the properties of the black-oxide layer instead of adding further properties of the additional elements.

As a result of the production as an alloyed black-oxide layer, the metallic additional elements are essentially integrated through the radial thickness of the black-oxide layer, or at least over a significant part of its thickness. In contrast to previous production methods, wherein additive elements are present only in the radial edge regions of the black-oxide layer, i.e., on the surface of the black-oxide layer or in open cavities and pores on the surface, the metallic additional elements provided here are to be found in the radial extension of the black-oxide layer, i.e., inside the layer structure and not just on its surface. In this way the metallic additional elements contribute to an improvement of the properties of the black-oxide layer over the thickness of the black-oxide layer.

During the run-in of a rolling-element bearing, a black-oxide layer necessarily and intentionally loses approximately 50% of its oxidation depth, while the remaining 50% then usually protects the surface as a remaining layer of the surface in a stable and long-term manner. It is thus only necessary to achieve a change of the layer properties up to more than 50% of the oxidation depth in order to modify the properties of the layer remaining after run-in. A change of the layer properties over the complete oxidation depth (thickness) of the black-oxide layer is desirable and ideally present, but is not absolutely necessary for the improved resistance of the layer.

According to one embodiment, the metallic additional elements are provided in a proportion between 0.1 and 1%, in particular between 0.3 and 0.7% (mass percentages) of the black-oxide layer. These small proportions of metallic additional elements do not change the overall properties of the black-oxide layer due to their own properties, but instead modify the properties of the actual black-oxide layer. The mass percentages used are similar to various alloying-element proportions in steel, wherein despite low concentration significantly below 1%, significant property changes are also achieved.

The low concentration of the additional elements allows on the one hand a resource-saving coating process without high chemical use, without high losses, and without high costs. On the other hand, the maintenance of the black oxidation bath and analytics is also simple.

If additional elements were to be embedded in a layer as “islands” in order to significantly change the overall properties of the layer due to the specific properties of the additional elements, a plurality of mass percentages of additional elements would have to be introduced into the layer. Such solid island formations could disrupt the homogeneous properties of the layer, endanger the internal stability, and would require a high material use of additional elements in the coating process.

If it is desired to position additional elements not on a layer but in a layer, it is therefore ideal when the additional elements are distributed in the layer by structural connections, for example, in the crystal lattice structure, or by chemical reactions, and are not present as insularly separated agglomerates. This is achieved by the bearing component described here. At the same time, incorporating the metallic additional elements in the base structure of the layer makes it possible to achieve relevant property improvements despite very low concentrations.

According to a further embodiment, the metallic additional elements are integrated in the black-oxide layer with a proportion that increases in a radially outward direction.

A black oxidation results from immersing the bearing component in one or more black oxidation baths. During immersion, iron or iron oxides contained in and on the material of the bearing component, e.g. steel, are partially dissolved and constantly redeposited and restructured. In contrast to a two-layer coating, in which a second coat has been applied to the unaltered static first layer, in a two-bath black oxidation the second bath also reforms the already deposited first oxidation layer once again. The resulting oxide layer is thicker and more stable; the proportion of free FeO decreases in favor of Fe₃O₄. The deeper the layer regions lie, the slower the reforming occurs, until it comes to a halt and has usually achieved its final desired oxidation state.

The metallic additional elements that are applied onto the bearing component, for example, by a pre-immersion solution, are not only embedded in the black-oxide layer but are also subjected to a dissolution reaction. This means that during the restructuring of the region in which the additional elements are embedded they can partially be lost again in the black oxidation bath.

If during the layer formation, the bearing component is again immersed in a suspension that includes metallic additional elements, in particular between the black oxidation baths, the concentration of the metallic additional elements increases again toward the layer surface, and the metallic additional elements diffuse in the black-oxide layer in the further reforming. Here a concentration gradient arises, since the deeper a layer region lies, the more poorly it can be “refilled” with metallic additional elements. In the end result a black oxidation arises having a measurable concentration gradient. The deepest regions of the layer have a lower content of metallic additional elements; toward the surface it is increasingly higher. Here, however, the metallic elements do not lie on the surface, but rather they are located in the black-oxide layer, predominantly in the upper regions, with a concentration gradient into the layer.

This differs from a conventional black oxidized surface in which additive elements only lie on the surface and are at best pressed into it in operation or deposited into the outwardly open pores of the black-oxide layer. In contrast thereto, in the bearing component described here the metallic additional elements are verifiably introduced into the microstructure of the black-oxide layer with a maximum concentration toward the black-oxide layer surface, but not above the surface of the black-oxide layer.

According to a further embodiment, the metallic additional elements are configured to change the properties of the black-oxide layer. As already mentioned above, the properties of the additional elements are not used directly, but rather the metallic additional elements serve to modify the already existing properties of the black-oxide layer, in particular to improve them.

In experiments it has been shown that the layer alloyed with metallic additional elements does not show a relevant difference to a conventional black-oxide layer either in the color or in the surface structure or porosity as viewed with a scanning electron microscope. In the scope of the determination precision, the corrosion protection is also identical, as is the friction. In roller contact no significant difference of the signs of wear has been shown. In contrast, in sliding tests, repeatable and significant differences have been shown between the bearing component described here and a bearing component including a conventional black-oxide layer.

Thus it has been shown that the signs of wear for the bearing component described here have been significantly reduced with all loads in the underlying test setup:

at 0.9 GPa from 0.85 μm to 0.50 μm (−41%)

at 1.1 GPa from 1.50 μm to 0.85 μm (−43%)

at 1.4 GPa from 2.15 μm to 1.20 μm (−44%)

In the examination using nano-indentation tests, the following improvements of the alloyed black-oxide layers described here have resulted in comparison to conventional black-oxide layers:

hardness increase of the alloyed black oxidation on smooth polished surfaces to 227%

hardness increase of the alloyed black oxidation on ground coarse surfaces to 192%

increase of the modulus of elasticity on smooth polished surfaces to 220%

increase of the modulus of elasticity on ground rough surfaces to 229%

In summary, due to the black-oxide layer described here, which has been alloyed with metallic additional elements, double the hardness, double the modulus of elasticity, and half the sliding wear can be achieved with respect to conventional black-oxide layers. Here, however, as already explained, no separate layer is provided by the metallic additional elements, but rather the “soft” black-oxide layer, which tends to wear out quickly under sliding conditions, is doubled in its relatively low hardness and resistance. Here the properties required for rolling contact are not negatively affected.

The alloyed black-oxide layer shows improved properties on existing sliding components. Since many rolling bearings, depending on their design and application, are configured to undergo a greater or lesser amount of sliding in addition to their rolling movement, the improved wear resistance during sliding movement is relevant for rolling bearings. Black oxide finishes on rolling bearings can not only be used to improve the performance of the raceways, but also to make the sliding displacement of the outer ring in the housing of non-locating bearings more gentle.

According to a further embodiment, the metallic additional elements can include titanium. In particular, the metallic additional elements include a metal oxide, in particular titanium oxide or titanium-iron oxide.

A black oxidation is Fe₃O₄ (magnetite), whose crystal structure has a cubic symmetry. When choosing the additional metallic elements, particular attention should be paid to adding or creating a compound that is as similar as possible to magnetite, in particular based on iron oxide. This compound should have approximately the same hardness and properties, but rather than a cubic symmetry it should have, for example, a trigonal s structure. Although the additional elements have similar properties but a different lattice structure, the assembly of the different lattice structures leads to a new and necessarily slightly distorted arrangement. The faults in the lattice structure and the available sliding planes can significantly change the hardness and the modulus of elasticity of the entire layer. The actual structure of a black oxidation, described only in a simplified manner as Fe₃O₄, is a significantly larger structural arrangement of the approximate description Fe₁₁O₁₆, and can therefore be effectively strained by addition of very low proportions of other related lattice structures, in particular at the Fe fault. Similar effects are measurable from the combination of Fe₃O₄ with an excess of Fe₂O₃.

Ilmenite (FeTiO₃), for example, which has all desired properties can be used as an addition in the layer structure. It is black, as is usual with a black oxidation. It has a Mohs hardness similar to that of magnetite. It is also an iron oxide. It has a trigonal structure and thus the potential to strain and harden a cubically built layer in the lattice. It has Ti as an easily detectable element, which provides information about the Ilmenite content of the layer. Since Ilmenite uses only one Fe atom in its structure, it cannot prevent in all conceivable concentrations the formation of Fe₃O₄ taking place in parallel. The excess oxygen from the nitrite of the black oxidation bath can always cover the formation requirement of the Ilmenite.

Further mixed oxides are conceivable. In addition to the Ilmenite (FeTiO₃), FeTiO₄ (iron (II) titanate) and FeTiO₅ are also possible in the black-oxide layer. In the event of oxygen excess, in addition to the three iron oxides FeO, Fe₂O₃, and Fe₃O₄, a group of three iron-titanium oxides can thus be present, namely FeTiO₃, FeTiO₄, and FeTiO₅.

Mixed oxides can preferably be combined with other mixed oxides. In the event of an imprecisely maintained oxygen ratio in the black oxidation bath, a closely related iron-titanium oxide ratio is thereby generated, instead of the reaction being allowed to drift in other undesirable directions. Each of the iron titanium oxides is suited to structurally distort the magnetite of the black-oxide layer.

Various titanium compounds can be used for the pre-immersion. These are all water-insoluble, for which reason a suspension is generated in the immersion bath via air injection for the metallic additional elements, as is common, for example, prior to a phosphating process (using partially different materials). In an analogous manner to such an activation, at least one pre-immersion bath including an aqueous suspension is made available in the coating system, into which pre-immersion bath the workpiece is immersed prior to the first black oxidation step and possibly repeatedly as a brief interruption during the black oxidation period.

An extremely cost-effective and non-toxic titanium compound with high market availability worldwide is titanium dioxide, which is also inert and does not lead to any undesirable side reactions. With the use in a suspension there is no risk with respect to inhalation. For the preparing of the suspension suitable particle sizes are specified, in particular KA 100 (0.25-0.35 mm).

Titanium dioxide is optionally present in the compositions rutile, anatase and brookite, which are not equivalent in use. Industrially the pigment is usually defined by the color strength and the degree of whiteness. Rutile can preferably be used for the suspension, which simultaneously has the greatest color strength and represents the most widely used composition in trade. Thus a raw material having a color strength of at least 1280 is preferably defined for the pre-immersion process. Further raw material properties for a successful use can be, for example, the oil number (preferably at most 25 g/100 g), the sieved residue 45 (preferably <0.015%) and the degree of purity (preferably >98%).

Since titanium dioxide has an influence on the oxidation behavior of iron, it can preferably be used as a metallic additional element. Titanium dioxide (TiO₂) advantageously changes the ionic diffusion of the oxygen anion O with iron and iron oxide. Here an outer Fe cation diffusion is replaced by an inner O anion diffusion. This means that the addition of TiO₂ not only improves the diffusion capacity of the oxygen anion in the substrate and the black-oxide layer and supports the layer formation, but also the dominant ion transfer mechanism for the oxidation of iron is exchanged in favor of a more efficient variant.

It has been established that the incorporation of titanium compounds in the black-oxide layer follows a natural mass ratio. The black-oxide layer typically contains approximately 0.4-0.7% titanium. If the pre-immersion suspension is driven with greatly increased titanium dioxide concentration, for example, with double concentration, the same result nonetheless arises. This is due to the fact that the incorporation of titanium mixture oxides in the structural Fe₁₁O₁₆ matrix follows a certain ratio, and a chemical reaction can also only process certain proportions of the reaction partners. This fact allows a particularly simple and stable bath control of the pre-immersion suspension, since it can be driven with a concentration excess as chemical supply, and despite variable concentration the same result is always achieved.

While the nominal ideal concentration of titanium dioxide in the pre-immersion suspension has been fixed at 10 g/liter, the equally functionally efficient tolerance range could be set at 5-20 g/liter without result variations arising.

The temperature of the pre-immersion suspension also does not lead to changes in the result. Room temperature and a higher temperature produce the same adhesive seed deposition with the same intensity and similar adhesion. In order to ensure the process stability of the pre-immersion, in addition to a stable suspension by continuous and sufficient air injection via nozzle pipes at the container base for the purpose of intensive circulation and holding in suspension, a bath step with deionized water, or water demineralized in another manner, as well as a sufficient dwell time of the workpiece in the suspension is to be observed. For the first adhesive seed deposition on a bare steel surface, a submerged dwell time of typically 2 to 5 minutes is required. With an already existing black-oxide layer, a changed surface energy and structure are present, and the intermediate immersion processes can be shorter. Due to the possibility of shorter intermediate immersions, the core temperature of the workpieces can be prevented from dripping to a relevant degree, which would extend the duration of the entire process.

According to a further aspect, a method is disclosed for manufacturing a bearing component as is described above. The method includes the following steps: depositing metallic additional elements on the bearing component and immersing the bearing component including the deposited metallic additional elements in a black oxidation solution, wherein the metallic additional elements are integrated in the structure of the black-oxide layer, and preferably over the approximately complete radial extension (thickness) of the black-oxide layer.

In particular, the deposition of the metallic additional elements can be effected by immersion in a pre-immersion solution. If titanium dioxide powder is used as metallic additional element, it can be present in the pre-immersion solution as a suspension with a particle size of 0.25-0.35 mm. As has been established, approximately 10 g/liter are sufficient here. Higher concentrations are possible, but not necessary.

Due to such a simple and cost-effective pre-immersion solution, an alloyed black oxidation can be reliably generated, which despite very low content of alloy components, i.e., components of metallic additional elements, in a plurality of properties a doubling is shown in their capability, as is described above. The result of this is that with such an alloyed black-oxide layer in rolling bearing applications where above normal amounts of sliding occur, no premature losses of the black-oxide layer occur.

According to a further embodiment, the steps of depositing metallic additional elements and immersion in the black oxidation solution are repeated, wherein the immersion in the black oxidation solution is respectively the step following a deposition. Furthermore, prior to the deposition of the metallic additional elements, a (multi-step) de-greasing and rinsing of the bearing component can first be performed.

An exemplary method including a plurality of pre-immersion or intermediate-immersion and black oxidation processes can take place as follows:

degreasing, cleaning, and rinsing of the material surfaces, optionally including further activating aids,

pre-immersion in a titanium dioxide suspension, which can be performed at room temperature as well as at increased temperature,

transferring into a first black oxidation bath,

optionally an interruption during the first black oxidation, for example, after 10 minutes, for renewed quenching and intermediate immersion in the same titanium dioxide suspension, including lifting-back and further black oxidation,

after conclusion of the first black oxidation, quenching in coolest-possible water,

pre-immersion in a further titanium dioxide suspension, which can be performed at room temperature as well as at increased temperature. This can be a second pre-immersion container in order to not impede the systems,

transferring into a second black oxidation bath,

optionally an interruption during the second black oxidation, for example, after 10 minutes, for renewed quenching and intermediate immersion in the same titanium dioxide suspension, including lifting-back and further black oxidation,

after conclusion of the second black oxidation, quenching in coolest-possible water,

finally various cold and hot rinsing baths, then processing with dewatering fluid and preserving oil.

The method can be expanded as needed to include a third pre-immersion container and a third black oxidation bath, as well as a third quenching rinse.

Compared to a modified black oxidation system typically used in the rolling-element bearing industry for tribological two-bath black oxidation, only two further containers are required for the alloyed black oxidation, which except for an air injection require no special obligatory equipment, in particular no heating or cooling, no protective covers, and no particularly high-grade materials. The driving of this additional container can be electively switched on or off in the operating program for the individual workpiece type without any adjustments or changes being required between the batches including alloyed and unalloyed black oxidation.

The above-mentioned pre-immersion tanks can include a titanium dioxide water suspension, whose TiO₂ is held in suspension under continuous air injection. If the bearing component is immersed here, the surface of the bearing component is seeded with titanium dioxide. The bearing component is then driven into the first black oxidation bath in a direct manner without rinsing. Here the immediate layer reaction takes place using the titanium dioxide present. As is known with seedings of phosphating, this seeding also does not release from the surface when directly lifted, while intermediate rinsing steps are avoided. Excess quantities of titanium dioxide, which can be released during immersing in the black oxidation bath, enter into the black oxidation bath sludge and are not harmful. It has been established that titanium dioxide cannot be held in suspension in the boiling black oxidation bath, but rather precipitates immediately. This can then be disposed of together with the black oxidation bath sludge.

The black oxidation bath is thus in no way contaminated or diminished and can likewise be used at any time for normal black oxidation without the layer thus generated containing any Ti. This has the advantage that the same black oxidation bath can be used for different black oxidation processes with or without metallic additional elements from a preceding pre-immersion step. Depending on the product and other requirements, the same system can thus alternatingly generate unalloyed tribological black-oxide layers or alloyed tribological black-oxide layers without these processes interfering with each other.

With a tribological rolling-element bearing black oxidation, which is described here, the total black oxidation period is distributed over a plurality of black oxidation steps. With particularly long black oxidation periods in a black oxidation bath, the process is usually interrupted by an intermediate quenching in a water bath in order to saturate high-oxygen-affinity elements and re-activate the surface. As described above, a separate pre-immersion in a titanium dioxide suspension, or a different pre-immersion solution, can therefore be effected before each black oxidation bath and each black oxidation step. There is thus no complication or delay of the coating process. This intermediate immersion leads to a renewed accumulation on the surface of the bearing component in order to compensate for losses of the titanium dioxide and to restore the natural Ti content of the layer of approximately 0.5%.

The features described in connection with the method likewise apply for the bearing component and vice versa.

Further advantages and advantageous embodiments are specified in the description, the drawings, and the claims. Here in particular the combinations of features specified in the description and in the drawings are purely exemplary, so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWING

FIG. 1 is a schematic illustration of a method for manufacturing a bearing component according to the present disclosure.

### DETAILED DESCRIPTION

In the following, identical or functionally equivalent elements are designated by the same reference numbers.

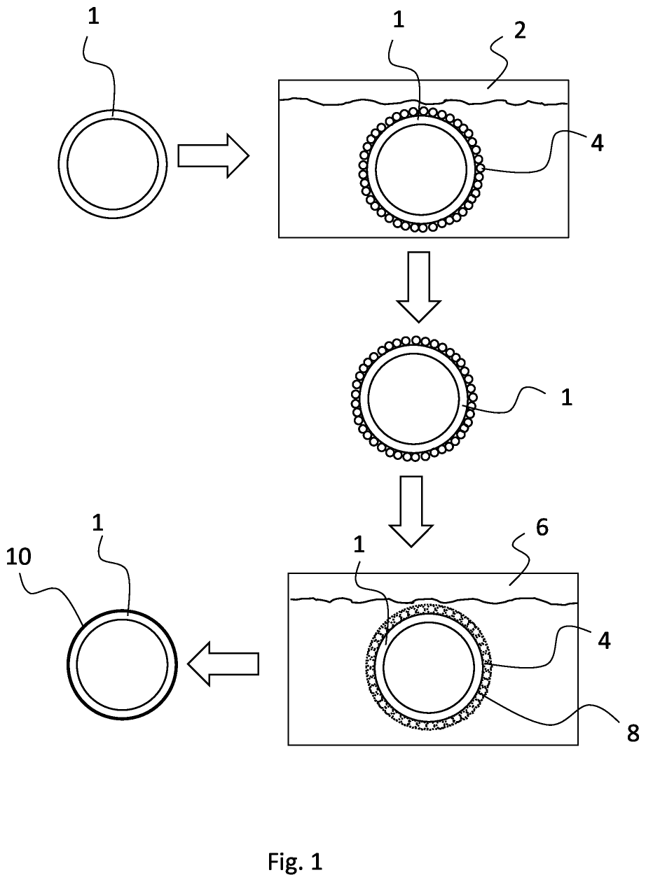

FIG. 1 schematically shows a possible process of a method for manufacturing a bearing component 1 including a black-oxide layer 10. Here the bearing component 1 is depicted by way of example as a rolling-element bearing ring, but any other arbitrary bearing component, for example, a rolling-element, can be provided with such a black-oxide layer 10.

The bearing component 1 is first immersed in a pre-immersion solution 2 in which metallic additional elements are present. These metallic additional elements can be, for example, titanium dioxide that is present in a titanium dioxide suspension in the pre-immersion solution 2. Due to the immersion of the bearing component 1 in the pre-immersion solution 2, the metallic additional elements are deposited on the surface of the bearing component 1, as is depicted here by way of example by beads 4 at the surface of the bearing component.

The bearing component 1 is then transferred into a black oxidation bath 6. In this black oxidation bath 6 a transformation of the bearing component surface into a black-oxide layer 8 is effected. Here a releasing of iron and iron oxides that are contained in the material of the bearing component 1 and their continuous redepositing and restructuring occurs. Here the metallic additional elements 4 that are already deposited on the bearing component 1 are embedded in the black-oxide layer 8. In particular, the metallic additional elements are embedded in the structure of the black-oxide layer 8.

Here the pre-immersion and black oxidation in the pre-immersion solution 2 and the black oxidation can be repeated as often as desired, preferably two to three times. Furthermore, a quenching of the bearing component 1 can be effected after each black oxidation bath 6.

After conclusion of the black oxidation, a bearing component 1 is then present that includes a homogeneous alloyed black-oxide layer 10. The metallic additional elements 4 are embedded therein over the entire radial extension and not recognizable as separate elements. Only a possible additional-element excess could appear as a local concentration peak but without being functionally disadvantageous. The metallic additional elements 4 serve in particular to adapt the properties of the black-oxide layer 8 and do not contribute with their own properties.

Due to this alloyed black-oxide layer 10, it can be achieved in particular that the properties of a black-oxide layer are improved with respect to wear resistance and degree of wear.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing components having black oxide layers.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing component
2 Pre-immersion solution
3 Metallic additional elements
6 Black oxidation solution
8 Black-oxide layer
10 Alloyed black-oxide layer

What is claimed is:

1. A bearing component that includes a black-oxide layer,
wherein metallic additional elements are integrated in the structure of the black-oxide layer.

2. The bearing component according to claim 1,
wherein the metallic additional elements are from 0.1 to 1 mass percent of the black-oxide layer.

3. The bearing component according to claim 1,
wherein the metallic additional elements are from 0.3 to 0.7 mass percent of the black-oxide layer.

4. The bearing component according to claim 3
wherein the metallic additional elements include titanium.

5. The bearing component according to claim 1,
wherein a concentration of the metallic additional elements integrated in the black-oxide layer decreases in a direction away from a surface of the black-oxide layer.

6. The bearing component according to claim 1, wherein the metallic additional elements are configured to change the properties of the black-oxide layer.

7. The bearing component according to claim 1,
wherein the metallic additional elements include a metal oxide.

8. The bearing component according to claim 7,
wherein the metal oxide comprises titanium oxide and/or titanium-iron oxide.

9. The bearing component according to claim 1, wherein the bearing component is a rolling-element bearing ring or a rolling element.

10. The bearing component according to claim 1,
wherein metallic additional elements are integrated in a lattice structure of the black-oxide layer.

11. The bearing component according to claim 10,
wherein the black oxide lattice structure has a cubic crystal symmetry and the metallic additional elements have a trigonal lattice structure.

12. The bearing component according to claim 11,
wherein the metallic additional elements are from 0.3 to 0.7 mass percent of the black-oxide layer.

13. The bearing component according to claim 10,
wherein the black oxide lattice structure has a first crystal symmetry and the metallic additional elements have a second crystal symmetry different than the first crystal symmetry.

14. The bearing component according to claim 10,
wherein the black oxide layer includes magnetite and the metallic additional elements include titanium.

15. A method for manufacturing a bearing component comprising:
a) depositing metallic additional elements on the bearing component, and
b) immersing the bearing component, including the deposited metallic additional elements, in a black oxidation solution to form a black-oxide layer in which the metallic additional elements are integrated.

16. The method according to claim 15,
wherein depositing the metallic additional comprises immersing the bearing component in a solution before immersing the bearing component in the black oxidation solution.

17. The method according to claim 16,
wherein the solution comprises titanium dioxide.

18. The method according to claim 15,
including repeating steps a and b.
